(19) United States
(12) Patent Application Publication
(10) Pub. No.: US 2002/0128327 A1
(43) Pub. Date: Sep. 12, 2002

(54) Polishing composition and magnetic recording disk substrate polished with the polishing composition

(75) Inventors: Ken Ishitobi, Shiojiri-shi (JP); Tetsuro Kumita, Nagoya-shi (JP); Kimihiro Hon, Nogoya-shi (JP); Yoshinori Suzuki, Nogoya-shi (JP)

Correspondence Address: SUGHRUE MION, PLLC, 2100 Pennsylvania Avenue, WNW, Washington, DC, 20037-3213, US

(73) Assignee: SHOWA DENKO K.K.

(21) Appl. No.: 10/042,154

(22) Filed: Jan. 11, 2002

Related U.S. Application Data
(63) Continuation-in-part of application No. PCT/JP01/05800, filed on Jul. 4, 2001.
(60) Provisional application No. 60/260,883, filed on Jan. 12, 2001.

(30) Foreign Application Priority Data
Jul. 5, 2000 (JP) 2000-204163

(51) Int. Cl. B01F 3/12

(52) U.S. Cl. 516/93

(57) ABSTRACT

A polishing composition includes at least water, alumina and a sol product derived from an aluminum salt. A magnetic recording disk substrate polished with the polishing composition suppresses formation of roll-off on the outer peripheral portion thereof, has a high-quality mirror-finished surface with few pits, nodules and scratches, and enables a distance between it and a magnetic head to be small, thereby making it possible to the recording density.

### CROSS REFERENCE TO RELATED APPLICATIONS

This application is an application filed under 35 U.S.C. §111(a) claiming the benefit pursuant to 35 U.S.C. §119(e) (1) of the filing date of Provisional Application No. 60/260,883 filed Jan. 12, 2001 pursuant to 35 U.S.C. §111(b), and is a Continuation-in-Part application of pending PCT/JP01/05800, filed Jul. 4, 2001.

### BACKGROUND OF THE INVENTION

1. Field of the Invention

The present invention relates to a polishing composition and, more particularly, to a composition for polishing a substrate of a magnetic recording disk to be incorporated into a rigid disk drive included in a computer and to a method of producing a magnetic recording disk substrate polished with the polishing composition.

2. Description of the Prior Art

Conventionally, there have been proposed a variety of compositions for polishing a magnetic recording disk substrate that exhibit a high polishing rate and provide, on the surface of a substrate, few defects such as scratches, pits and nodules, and little polishing-induced damage. For example, JP-A-SHO 61-291674 discloses a polishing composition containing sulfamic acid or phosphoric acid, JP-A-SHO 62-25187 a polishing composition containing aluminum nitrate, and JP-A-HEI 2-158682 a polishing composition containing a metal nitrite.

JP-A-HEI 4-275387 discloses a polishing composition containing two types of polishing accelerators, one of which is aluminum sulfate or aluminum chloride and the other of which is a peroxide, nitric acid, a nitrate salt, a nitrite salt or an aromatic nitro compound.

In addition, polishing compositions containing boehmite, boehmite alumina sol or colloidal alumina as a polishing accelerator, are disclosed as effective compositions for yielding a high-quality polished surface without generating surface defects.

Other polishing compositions are reported, for example, in JP-A-HEI 1-188264 (a composition containing alumina added with boehmite), JP-A-HEI 1-205973 (a composition containing alumina added with a metal salt and boehmite), JP-A-HEI 2-84485 (a polishing composition comprising gluconic acid, lactic acid, sodium salts thereof and colloidal alumina), JP-A-HEI 2-158683 (a composition containing alumina added with boehmite and an ammonium salt of an inorganic or organic acid), JP-A-HEI 3-115383 (a composition containing alumina added with boehmite and a water-soluble peroxide), JP-A-HEI 4-363385 (a composition containing alumina added with a chelate compound, boehmite, and an aluminum salt), and JP-A-HEI 11-92749 (a composition comprising alumina, boehmite and a polyamine chelate compound or a polyaminocarboxylic acid chelate compound).

These compositions have been developed so as to provide a high-quality polished surface having no surface defects such as pits, nodules and scratches, while maintaining a high polishing rate.

However, in the rapidly growing field of computer hardware, since the narrower the distance (flying height) between a magnetic head and a magnetic recording disk in a rigid disk drive, the higher the recording density, a ceaseless demand is posed for a magnetic recording disk having a higher-quality finished surface. However, hitherto, no magnetic recording disk fully satisfying such a ceaseless demand for practical performance has yet been produced.

In order to enhance the recording density as described above, the disk substrate must have a high degree of flatness; low surface roughness; and no pits, nodules or scratches, and must have little roll-off that would possibly be formed on the outer peripheral end portion of a disk. In the case in which a polished surface of high quality having, among other properties, a surface roughness Ra of approximately 15 Å or less is demanded, ultramicro-scale pits and nodules, which have conventionally been accepted, pose a problem. Therefore, there is a demand for an excellent polishing composition that can provide a finished surface of high quality.

In order to satisfy these demands, an object of the present invention is to provide a polishing composition that can provide a high-quality polished surface having no surface defects while maintaining a high polishing rate. More particularly, the object is to provide a polishing composition that, during polishing of a Ni−P-plated aluminum substrate of a magnetic recording disk, attains high polishing efficiency and can form an excellent polished surface having high smoothness and no surface defects.

### SUMMARY OF THE INVENTION

To attain the above object, the present invention provides a polishing composition comprising at least water, alumina and a sol product derived from an aluminum salt.

The polishing composition can further contain a polishing accelerator.

The polishing accelerator is at least one species selected from the group consisting of organic acids, inorganic acids and salts thereof.

The sol product is a mixture of an aluminum salt with at least one species selected from the group consisting of sodium hydroxide, potassium hydroxide, ammonia, organic amine compounds, amine chelate compounds, aminocarboxylic acids, aminocarboxylic acid chelate compounds and aminophosphonic acid chelate compounds.

The sol product can be a mixture of at least one species selected from among hydrates and anhydrates of aluminum salts including inorganic acid aluminum salts that include aluminum sulfate, aluminum chloride, aluminum nitrate, aluminum phosphate and aluminum borate, and organic acid aluminum salts that include aluminum acetate, aluminum lactate and aluminum stearate with at least one species selected from among sodium hydroxide, potassium hydroxide, ammonia, organic amine compounds, amine chelate compounds, aminocarboxylic acids, aminocarboxylic acid chelate compounds and aminophosphonic acid chelate compounds.

The sol product can be a mixture of at least one aluminum salt selected from the group consisting of aluminum sulfate, aluminum chloride and aluminum nitrate with at least one compound selected from the group consisting of sodium hydroxide, potassium hydroxide, ammonia, triethanolamine and aminotrismethylenephosphonic acid.

The polishing accelerator is contained in an amount of 0.01-10 mass %.

The sol product is contained in an amount of 0.01-5 mass %.

The present invention further provides a method of producing a sol product derived from an aluminum salt, which comprises mixing, by means of a stirrer, an aluminum salt with at least one species selected from the group consisting of sodium hydroxide, potassium hydroxide, ammonia, organic amine compounds, amine chelate compounds, aminocarboxylic acids, aminocarboxylic acid chelate compounds and aminophosphonic acid chelate compounds.

In the method of producing a sol product described above, the aluminum salt is at least one species selected from the group consisting of aluminum sulfate, aluminum chloride and aluminum nitrate.

In the method of producing a sol product described above, the stirrer is a high-shear stirrer.

The present invention further provides a method of producing a magnetic recording disk substrate, which comprises rotating at least one of a magnetic recording disk raw substrate and a polishing pad while any one of the polishing compositions is fed into a space between the substrate and the pad.

In the method of producing a magnetic recording disk substrate described above, the magnetic recording disk raw substrate is an aluminum disk raw substrate that is chemically plated with Ni—P.

According to the polishing composition of the present invention that contains a sol product derived from an aluminum salt, it is possible to obtain a substrate that has suppressed roll-off from being formed on the outer peripheral end portion of a disk and has a mirror-finished surface of high quality with no surface defects while maintaining a high polishing rate. When the substrate is used as a magnetic recording disk, it is possible to make the distance between it and a magnetic head narrower, thereby enhancing the recording density.

The above and other objects, features and advantages will become apparent from the description made with reference to the accompanying drawings.

### BRIEF DESCRIPTON OF THE DRAWINGS

FIG. 1 is a schematic view showing the constitution of one example of a high-shear stirrer used for producing a sol product according to the present invention.

FIG. 2 is an explanatory sketch for determining the amount of roll-off of a polished disk.

### DESCRIPTION OF THE PREFERRED EMBODIMENT

The present invention is directed to a polishing composition comprising water, alumina and a sol product derived from an aluminum salt. Preferably, the composition further contains a polishing accelerator in addition to the above components. More particularly, the present invention is directed to a polishing composition into which a sol product derived from an aluminum salt is incorporated, wherein the sol product is formed through reaction between an aluminum salt and a compound, such as an inorganic alkaline compound which dissociates a hydroxide ion in an aqueous solution, or ammonia or an amine compound which generates a free hydroxide group through hydration.

The sol product derived from an aluminum salt effectively enhances the polishing rate synergistically with the polishing accelerator, modifies the viscosity of the entire composition and enhances dispersibility and re-dispersibility of alumina particles. In addition, the sol product enhances retention of alumina on a polishing pad to thereby reduce the amount of roll-off.

No particular limitation is imposed on the alumina that is used in the present invention, and alumina of any crystal structure type such as α, θ or γ may be used. Of these, α-alumina is preferred from the viewpoint of provision of a high polishing rate. Although no particular limitation is imposed on the particle size of alumina, the average particle size is preferably 0.02-5 μm, more preferably 0.3-2 μm. In the present invention, the average particle size may be appropriately determined in accordance with the target surface roughness to be attained.

The polishing composition used in the present invention preferably contains alumina in an amount of 1-30 mass %, more preferably 3-20 mass %.

The sol product derived from an aluminum salt that is used in the polishing composition of the present invention is obtained by adding, while mixing by means of a high-shear stirrer, at least one species selected from the group consisting of sodium hydroxide; potassium hydroxide; ammonia; an organic amine compound, such as a C1-C10 alkylamine (e.g., monomethylamine, dimethylamine, trimethylamine or methyl-ethylamine) or a hydroxyalkylamine (e.g., triethanolamine); a (poly)amine chelate compound (ethylenediamine, diethylene-triamine or bipyridine); an aminocarboxylic acid (also called amino acid, such as glycine or glutamic acid); a (poly)amino-carboxylic acid chelate compound (e.g., ethylenediamine-tetraacetic acid (EDTA), diethylenetriaminepentaacetic acid (DTOA), nitrilotriacetic acid (NTA), or iminodiacetic acid); and an aminophosphonic acid chelate compound, such as diethylene-triaminepentamethylenephosphonic acid or aminotrismethylene-phosphonic acid), to an aqueous solution containing, in the form of hydrate or anhydrate, at least one species selected from among inorganic acid aluminum salts, such as aluminum sulfate, aluminum chloride, aluminum nitrate, aluminum phosphate and aluminum borate; and organic acid aluminum salts, such as aluminum acetate, aluminum lactate and aluminum stearate. Mixing an aluminum salt with a substance (e.g., ammonia or amine) that readily generates a free hydroxide group upon reacting with water; a compound having a terminal hydroxide group; or a compound having a hydroxide group such as sodium hydroxide or potassium hydroxide forms a chain-structure substance in which the component compounds are linked in a chain form.

The stirring step taken when obtaining the sol product derived from an aluminum salt is performed using a high-shear stirrer that can give high shearing force to the raw material mixed solution of the aluminum salt. This enables formation of a sol product suitable for polishing a magnetic recording disk substrate.

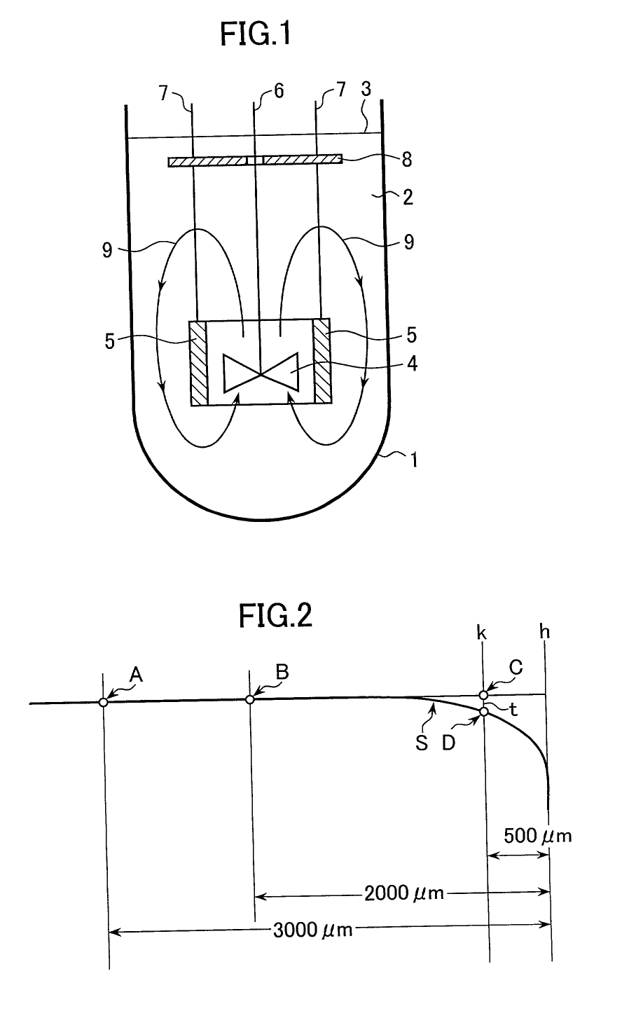

FIG. 1 shows one example of a stirrer that performs high-shear stirring, in which a shield cylinder 5 equipped therein with a turbine 4 is provided within a stirrer vessel 1 as supported by support rods 7 in a suspending manner.

In the stirrer having the above structure, when the turbine 4 is rotated at high speed via a turbine shaft 6, the raw material mixed solution of the aluminum salt is stirred within the shield cylinder 5 while being given a shearing force. The solution ascends in the form of a convection current from an upper opening of the shield cylinder 5, forms a downward convection current 9 along the inside peripheral wall of the stirrer vessel in the presence of a commutation plate 3 provided in the vicinity of a liquid level 3, ascends toward a lower opening of the shield cylinder 5 at the lower side of the stirrer vessel, again undergoes high-shear stirring within the shield cylinder 5, and is circulated by convection within the stirrer vessel 1. As a result, a sol product is obtained.

The number of revolutions of the turbine 4 in the high-shear stirrer varies depending on the size of the stirrer vessel 1, shape of the turbine 4 and volume of the shield cylinder 5. When the stirrer vessel 1 has a volume of 2-20 liters, the turbine is rotated at 500-12,000 rpm, preferably 6000-10,000 rpm, more preferably 7,000-9,000 rpm. When the volume of the stirrer vessel is twice, the number of revolutions of the turbine should preferably be about one second. When the stirrer vessel 1 has a volume of 2-20 liters, the stirring time is 15-60 minutes. It is necessary to increase the stirring time with increasing volume of the vessel.

The present inventors have analyzed the structure of the sol product through X-ray diffraction and NMR. The analysis revealed that sol products according to the present invention; e.g., those produced from aluminum sulfate and ammonia; aluminum chloride and ammonia; aluminum sulfate and sodium hydroxide; and aluminum sulfate and triethanolamine, exhibit no characteristic peak attributed to pseudo-boehmite or a similar species and exhibit broad diffraction patterns, whereas a sol product obtained from boehmite alumina with gluconic acid or aluminum nitrate exhibits a peak attributed to pseudo-boehmite crystals. Thus, the structure of the sol products of the present invention is considered to be amorphous.

Although the above results reveal no clear network structure in the sol products according to the present invention, it is considered that the structure is formed by bonding Al atoms with free hydroxide groups to form aluminum hydroxide Al(OH)₃ of a bayerite structure, and further hydrating the aluminum hydroxide to thereby form amorphous hydrated alumina AL(OH)3.nH₂O sol.

The composition including the sol product of the present invention contains an aluminum salt in an amount of 0.01-5 mass %, preferably 0.05-2 mass %. When the amount is less than 0.01 mass %, desirable effects cannot be attained, whereas when the amount is in excess of 5 mass %, the composition gels, and surface defects such as pits and nodules are formed.

In one mode of the present invention, an organic acid or an inorganic acid salt may be employed as the polishing accelerator. The organic acid may be at least one species selected from the group consisting of malonic acid, succinic acid, adipic acid, lactic acid, malic acid, citric acid, glycine, aspartic acid, tartaric acid, gluconic acid, peptogluconic acid, iminodiacetic acid and fumaric acid. The inorganic acid salt may be at least one species selected from the group consisting of sodium sulfate, magnesium sulfate, nickel sulfate, aluminum sulfate, ammonium sulfate, nickel nitrate, aluminum nitrate, ammonium nitrate, ferric nitrate, aluminum chloride and nickel sulfamate.

The amount of the organic acid or the inorganic acid salt is 0.01-10 mass %, preferably 0.1-2 mass %. When the amount is less than 0.01 mass %, the effect of the polishing accelerator cannot be attained, whereas when the amount is in excess of 10 mass %, pits and nodules are generated to thereby deteriorate the quality of the polished surface. In addition, aggregation of alumina particles, which is undesirable for the liquid property, occurs.

In another mode of the present invention, as the polishing accelerator, a combination of an organic acid and an organic or inorganic acid salt may be used. Similarly to the above case, the organic acid may be at least one species selected from the group consisting of malonic acid, succinic acid, adipic acid, lactic acid, malic acid, citric acid, glycine, aspartic acid, tartaric acid, gluconic acid, peptogluconic acid, iminodiacetic acid and fumaric acid. The organic acid salt may be at least one species selected from the group consisting of a potassium salt, a sodium salt and an ammonium salt of the aforementioned organic acids.

Similarly to the above case, the inorganic acid salt may be at least one species selected from the group consisting of sodium sulfate, magnesium sulfate, nickel sulfate, aluminum sulfate, ammonium sulfate, nickel nitrate, aluminum nitrate, ammonium nitrate, ferric nitrate, aluminum chloride and nickel sulfamate. In all combinations of the organic acid and the organic acid salt and/or the inorganic acid salt, the total amount of the acids and salts is 0.01-10 mass % based on the total amount of the polishing composition, more preferably 0.1-2 mass %. Among these components, the amount of the organic acid must be adjusted to at least 0.003 mass %.

When the total amount of any combination in the polishing accelerator is less than 0.01 mass %, the polishing acceleration effect becomes poor, whereas when the amount is in excess of 10 mass %, the viscosity of a polishing composition solution increases excessively, aggregation of alumina particles undesirable for the liquid property occurs, and pits and nodules are generated on the polished surface, to thereby disadvantageously lower the quality. In the case in which an organic acid and an organic acid salt and/or an inorganic acid salt are used in combination, a combination of acids of the same species yields better polishing characteristics.

In addition to the aforementioned components, the polishing composition of the present invention may contain, as an additive and in accordance with needs, any of alumina sol, a surfactant, a detergent, an anticorrosive agent, an antiseptic agent, a pH-controlling agent, a thickener and a surface-modification agent such as cellulose, sulfamic acid or phosphoric acid.

The polishing composition of the present invention preferably has a pH of 2-6.

A magnetic recording disk substrate can be obtained using the polishing composition in the same manner as in the conventional method that comprises feeding the polishing composition between the surface of a magnetic recording disk raw substrate to be polished and a polishing pad and rotating at least one of the raw substrate and the polishing pad to permit the polishing composition to slide on the surface.

The present invention will next be described in more detail by way of examples, which should not be construed as limiting the invention thereto.

### EXAMPLES

Sixteen polishing compositions prepared to comprise different components are shown as Examples 1 to 16 in Table 1, and ten polishing compositions prepared to comprise different components and not to contain a sol product derived from an aluminum salt are shown as Comparative Examples 1 to 10 in Table 2. Hereunder, the method of preparing these polishing compositions, formulation examples of sol products derived from an aluminum salt, conditions for polishing a recording disk substrate, and a method for evaluating polishing characteristics of the substrate will be described.

(Preparation of Polishing Compositions)

Aluminum hydroxide was heated to about 1,200° C. in air in a firing furnace to obtain a-alumina. The thus-obtained a-alumina was crushed and subjected to wet-classification, thereby producing three alumina samples having respective mean particle sizes of 0.6 μm, 0.7 μm, and 1.0 μm. In each Example or Comparative Example, the specific aluminum salt and the ammonia or other basic compound were mixed at the compositional proportion shown in Table 1 or 2 to thereby prepare a sol product derived from the aluminum salt under the stirring conditions shown below. Formulation examples containing the respective sol products are collectively shown below.

Subsequently, on the basis of the respective compositions shown in Table 1 or 2, water, alumina, a sol product derived from an aluminum salt and a polishing accelerator were weighed, incorporated and mixed to thereby prepare the corresponding polishing composition samples.

(Formulation Examples for Producing a Sol Product Derived From an Aluminum Salt)

Formulation examples (proportions by weight) for producing a sol product derived from an aluminum salt are shown hereunder.

(1) Sol product derived from aluminum sulfate and ammonia:

water:aluminum sulfate (18 hydrate, employed hereinafter as aluminum sulfate):28% aqueous ammonia=20:5:3.6

(2) Sol product derived from aluminum sulfate and aminotris-methylenephosphonic acid (abbreviated as NTMP):

water:aluminum sulfate:NTMP=20:5:15

(3) Sol product derived from aluminum sulfate and diethylenetriaminepentamethylenephosphonic acid (abbreviated as DTPMP):

water:aluminum sulfate:DTPMP=20:5:15

(4) Sol product derived from aluminum sulfate and triethanolamine (abbreviated as TEA):

water:aluminum sulfate:TEA=20:5:15

(5) Sol product derived from aluminum chloride and ammonia:

water:aluminum chloride (hexahydrate):28% aqueous ammonia=20:5:3.6

(6) Sol product derived from aluminum nitrate and ammonia:

water:aluminum nitrate (nonahydrate, employed hereinafter as aluminum nitrate):28% ammonia water=20:5:3.6

(7) Sol product derived from aluminum nitrate and triethanolamine:

water:aluminum nitrate:TEA=20:5:15

(8) Sol product derived from aluminum sulfate and sodium hydroxide:

water:aluminum sulfate:50% sodium hydroxide=20:5:3

The amount of the sol product added to the composition (content) is defined as the total weight of the employed aluminum salt and the compound for forming the sol product, the water content of each component being subtracted.

(Stirring Conditions for Producing a Sol Product)

The raw mixed solution prepared in advance was subjected to high-shear stirring using the high-shear stirrer with the structure shown in FIG. 1 to thereby obtain a sol product.

The stirrer used was T. K. Homoxer, MK-II model of M-type, a product of Japan Special Machine Chemical Industry Co., Ltd. The stirring vessel had a volume of 2 liters, and the number of revolutions of the turbine in the shield cylinder was 8,000 rpm.

(Polishing Conditions)

An aluminum disk having a size of 3.5 inches chemically plated with Ni—P was employed as a workpiece to be polished. The polishing test and disk evaluation were carried out under the following conditions.

Polishing Test Conditions:

Polishing test machine: 9B double-sided polishing machine (a product of System Seiko)

Polishing pad: Politex DG

Number of revolutions of surface plate: upper surface plate 28 rpm, lower surface plate 45 rpm, Sun gear 8 rpm

Feed rate of slurry: 100 ml/min.

Polishing time: 5 minutes

Operation pressure: 80 g/cm²

(Disk Evaluation Method)

Polishing rate: calculated from difference in weight before and after polishing the disk

Quality of polished surface: pits, nodules and scratches on disks observed under a microscope and counted; specifically pits and nodules crosswise observed on both sides of five disks, and the number within the visual field (magnification: ×50) counted; and scratches crosswise observed on both sides of one disk, and the number within the visual field (magnification: ×100) counted.

Amount of roll-off: measured by use of a surfcorder, SE-30D model (a product of Kosaka Kenkyujo).

To be specific, the circumferential portion of the surface of a polished rigid disk is traced by use of a surfcorder to draw a curve S as shown in FIG. 2. A perpendicular line h is drawn along the circumferential edge of the curve S. Points on the curve S which are at 3,000 μm and 2,000 μm from the perpendicular line h towards the center of the disk are assigned as A and B, respectively. On an extension of the straight line passing the points A and B, a point which is at 500 μm from the perpendicular line h is assigned as C. A perpendicular line k is drawn so as to pass the point C, and a point at which the perpendicular line k and the curve S are crossed is assigned as D. The length t between the points C and D is determined as the amount of roll-off of the disk.

TABLE 1-1

| | α-Alumina | | | | | | Sol | | | | | |
|---|---|---|---|---|---|---|---|---|---|---|---|---|
| | Par- | | | | | | product | Evaluation of polishing | | | | |
| | ticle | | Polishing accelerator | | | | derived | Polish- | | | | |
| | size | | | | Acid salt ratio | | from Al | ing | Surface defects | | | |
| | D50 | Amount | Organic acid | | (organic/inorganic) | | salt | rate | Nod | Pit | Scr | ROA |
| Ex. | μm | % | Type | % | Type | % | % | μm/min | No. | No. | No. | Å |
| 1 | 0.7 | 6 | None | 0 | None | 0 | ALS/AM | 0.74 | 0 | 4 | 2 | 800 |
| | | | | | | | 1.0 | | | | | |
| 2 | 0.7 | 6 | Lac | 0.5 | Na lactate | 1.0 | ALS/AM | 1.27 | 0 | 2 | 1 | 450 |
| | | | | | | | 0.5 | | | | | |
| 3 | 0.6 | ditto | Lac | 0.5 | Na lactate | 1.0 | ALS/AM | 0.96 | 0 | 2 | 2 | 700 |
| | | | | | | | 0.5 | | | | | |
| 4 | 1.0 | ditto | Mal | 0.7 | Na malate | 0.2 | ALS/AM | 1.37 | 0 | 3 | 2 | 300 |
| | | | | | | | 0.5 | | | | | |
| 5 | 0.7 | ditto | Mal | 0.7 | Na malate | 0.2 | ALS/AM | 1.29 | 0 | 2 | 1 | 550 |
| | | | | | | | 0.5 | | | | | |
| 6 | 0.6 | ditto | Mal | 0.7 | Na malate | 0.2 | ALS/AM | 1.02 | 0 | 2 | 1 | 650 |
| | | | | | | | 0.5 | | | | | |
| 7 | 0.7 | ditto | Mal | 0.7 | Na malate | 0.2 | ALS/AM | 1.28 | 0 | 3 | 1 | 500 |
| | | | | | | | 1.0 | | | | | |
| 8 | 0.7 | ditto | Mal | 5.0 | Na malate | 4.0 | ALS/AM | 1.32 | 0 | 3 | 2 | 450 |
| | | | | | | | 1.0 | | | | | |

In the Table,
Lac: lactic,
Mal: malic,
ALS: aluminum sulfate,
AM: ammonia;
Nod: nodules,
Scr: scratches,
ROA: roll-off amount,
%: mass %

TABLE 1-2

| | α-Alumina | | | | | | Sol | | | | | |
|---|---|---|---|---|---|---|---|---|---|---|---|---|
| | Par- | | | | | | product | Evaluation of polishing | | | | |
| | ticle | | Polishing accelerator | | | | derived | Polish- | | | | |
| | size | | | | Acid salt ratio | | from Al | ing | Surface defects | | | |
| | D50 | Amount | Organic acid | | (organic/inorganic) | | salt | rate | Nod | Pit | Scr | ROA |
| Ex. | μm | % | Type | % | Type | % | % | μm/min | No. | No. | No. | Å |
| 9 | 0.7 | 6 | Mal | 0.7 | Na malate | 0.2 | ALS/TEA | 1.30 | 0 | 2 | 2 | 550 |
| | | | | | | | 0.5 | | | | | |
| 10 | 0.7 | ditto | Mal | 0.7 | Na malate | 0.2 | ALC/AM | 1.32 | 0 | 2 | 2 | 500 |
| | | | | | | | 0.5 | | | | | |
| 11 | 0.7 | ditto | Mal | 0.7 | Na malate | 0.2 | ALN/AM | 1.31 | 0 | 3 | 2 | 500 |
| | | | | | | | 0.5 | | | | | |
| 12 | 0.7 | ditto | Glu | 0.5 | Na gluconate | 0.5 | ALS/AM | 1.17 | 0 | 1 | 1 | 600 |
| | | | | | | | 0.5 | | | | | |
| 13 | 0.7 | ditto | Mal | 0.7 | — | — | ALS/AM | 1.24 | 0 | 4 | 2 | 550 |
| | | | | | | | 0.5 | | | | | |
| 14 | 0.7 | ditto | — | — | Al nitrate | 1.0 | ALS/AM | 1.26 | 0 | 3 | 2 | 450 |
| | | | | | | | 0.5 | | | | | |
| 15 | 0.7 | ditto | Mal | 0.7 | Ni sulfate | 0.3 | ALS/AM | 1.26 | 0 | 3 | 2 | 550 |
| | | | | | | | 0.5 | | | | | |
| 16 | 0.7 | ditto | Mal | 0.7 | Na malate | 0.2 | ALS/AM | 1.29 | 0 | 3 | 2 | 600 |
| | | | | | Al nitrate | 0.2 | 0.5 | | | | | |

In the Table,
Mal: malic,
Glu: gluconic,
ALS: aluminum sulfate,
ALC: aluminum chloride,
ALN: aluminum nitrate,
AM: ammonia;
Nod: nodules,
Scr: scratches,
ROA: roll-off amount,
%: mass %

TABLE 2

| | |
|---|---|
| α-Alumina | Sol |

| | Par- | | | | | | product | Evaluation of polishing | | | | |
|---|---|---|---|---|---|---|---|---|---|---|---|---|
| | ticle | | Polishing accelerator | | | | derived | Polish- | | | | |
| | size | | | | Acid salt ratio | | from Al | ing | Surface defects | | | |
| Comp. | D50 | Amount | Organic acid | | (organic/inorganic) | | salt | rate | Nod | Pit | Scr | ROA |
| Ex. | μm | % | Type | % | Type | % | % | μm/min | No. | No. | No. | Å |
| 1 | 0.7 | 6 | None | 0 | None | 0 | None | 0.56 | M | M | M | 2500 |
| 2 | 0.7 | 6 | Lac | 0.5 | Na lactate | 1.0 | None | 1.18 | 0 | 6 | 4 | 800 |
| 3 | 1.0 | ditto | Mal | 0.7 | Na malate | 0.2 | None | 1.27 | 0 | 8 | 5 | 1000 |
| 4 | 0.7 | ditto | Mal | 0.7 | Na malate | 0.2 | None | 1.18 | 0 | 7 | 3 | 1400 |
| 5 | 0.6 | ditto | Mal | 0.7 | Na malate | 0.2 | None | 0.93 | 1 | 9 | 3 | 1900 |
| 6 | 0.7 | ditto | Glu | 0.5 | Na gluconate | 0.5 | None | 1.08 | 0 | 6 | 4 | 1600 |
| 7 | 0.7 | ditto | Mal | 0.7 | — | — | None | 1.15 | 1 | 8 | 4 | 1800 |
| 8 | 0.7 | ditto | — | — | Al nitrate | 1.0 | None | 1.19 | 0 | 10 | 5 | 1250 |
| 9 | 0.7 | ditto | Mal | 0.7 | Ni sulfate | 0.3 | None | 1.17 | 1 | 8 | 4 | 1700 |
| 10 | 0.7 | ditto | Mal | 0.7 | Na malate | 0.2 | None | 1.20 | 1 | 10 | 4 | 1750 |
| | | | | | Al nitrate | 0.2 | | | | | | |

In the Table,
Lac: lactic,
Mal: malic,
Nod: nodules,
Scr: scratches,
ROA: roll-off amount,
M: many,
%: mass %

As described hereinabove, the polishing composition of the present invention comprising at least water, alumina and a sol product derived from an aluminum salt, and optionally a polishing accelerator attains a high polishing speed, a small amount of roll-off, and a high-quality mirror-finished surface free of surface defects that is optimal as the surface of a magnetic recording disk substrate.

As is clear from comparison between Tables 1 and 2, addition of the sol product reduces the amount of roll-off to one third or smaller, provides a polished surface of good surface properties with few pits, nodules and scratches, and attains a high polishing rate. By adding a polishing accelerator to the polishing composition of the present invention, the polishing rate can be further enhanced, attaining a remarkable effect, with the amount of roll-off enhanced to around 500 Å.

What is claimed is:

1. A polishing composition comprising at least water, alumina and a sol product derived from an aluminum salt.

2. A polishing composition according to claim 1, further comprising a polishing accelerator.

3. A polishing composition according to claim 2, wherein the polishing accelerator is at least one species selected from the group consisting of organic acids, inorganic acids and salts thereof.

4. A polishing composition according to claim 1, wherein the sol product is a mixture of an aluminum salt with at least one species selected from the group consisting of sodium hydroxide, potassium hydroxide, ammonia, organic amine compounds, amine chelate compounds, aminocarboxylic acids, aminocarboxylic acid chelate compounds and aminophosphonic acid chelate compounds.

5. A polishing composition according to claim 2, wherein the sol product is a mixture of an aluminum salt with at least one species selected from the group consisting of sodium hydroxide, potassium hydroxide, ammonia, organic amine compounds, amine chelate compounds, aminocarboxylic acids, aminocarboxylic acid chelate compounds and aminophosphonic acid chelate compounds.

6. A polishing composition according to claim 1, wherein the sol product is a mixture of at least one species selected from among hydrates and anhydrates of aluminum salts including inorganic acid aluminum salts that include aluminum sulfate, aluminum chloride, aluminum nitrate, aluminum phosphate and aluminum borate, and organic acid aluminum salts that include aluminum acetate, aluminum lactate and aluminum stearate with at least one species selected from among sodium hydroxide, potassium hydroxide, ammonia, organic amine compounds, amine chelate compounds, aminocarboxylic acids, aminocarboxylic acid chelate compounds and amino-phosphonic acid chelate compounds.

7. A polishing composition according to claim 2, wherein the sol product is a mixture of at least one species selected from among hydrates and anhydrates of aluminum salts including inorganic acid aluminum salts that include aluminum sulfate, aluminum chloride, aluminum nitrate, aluminum phosphate and aluminum borate, and organic acid aluminum salts that include aluminum acetate, aluminum lactate and aluminum stearate with at least one species selected from among sodium hydroxide, potassium hydroxide, ammonia, organic amine compounds, amine chelate compounds, aminocarboxylic acids, aminocarboxylic acid chelate compounds and amino-phosphonic acid chelate compounds.

8. A polishing composition according to claim 1, wherein the sol product is a mixture of at least one aluminum salt selected from the group consisting of aluminum sulfate, aluminum chloride and aluminum nitrate with at least one compound selected from the group consisting of sodium hydroxide, potassium hydroxide, ammonia, triethanolamine and aminotrismethylenephosphonic acid.

9. A polishing composition according to claim 2, wherein the sol product is a mixture of at least one aluminum salt selected from the group consisting of aluminum sulfate, aluminum chloride and aluminum nitrate with at least one compound selected from the group consisting of sodium hydroxide, potassium hydroxide, ammonia, triethanolamine and aminotrismethylenephosphonic acid.

10. A polishing composition according to claim 2, wherein the polishing accelerator is contained in an amount of 0.01-10 mass %.

11. A polishing composition according to claim 1, wherein the sol product is contained in an amount of 0.01-5 mass %.

12. A polishing composition according to claim 2, wherein the sol product is contained in an amount of 0.01-5 mass %.

13. A method of producing a sol product derived from an aluminum salt, which comprises mixing, by means of a stirrer, an aluminum salt with at least one species selected from the group consisting of sodium hydroxide, potassium hydroxide, ammonia, organic amine compounds, amine chelate compounds, aminocarboxylic acids, aminocarboxylic acid chelate compounds and aminophosphonic acid chelate compounds.

14. A method of producing a sol product according to claim 13, wherein the aluminum salt is at least one species selected from the group consisting of aluminum sulfate, aluminum chloride and aluminum nitrate.

15. A method of producing a sol product according to claim 13, wherein the stirrer is a high-shear stirrer.

16. A method of producing a sol product according to claim 14, wherein the stirrer is a high-shear stirrer.

17. A method of producing a magnetic recording disk substrate, which comprises rotating at least one of a magnetic recording disk raw substrate and a polishing pad while the polishing composition as recited in claim 1 is fed into a space between the substrate and the pad.

18. A method of producing a magnetic recording disk substrate, which comprises rotating at least one of a magnetic recording disk raw substrate and a polishing pad while the polishing composition as recited in claim 2 is fed into a space between the substrate and the pad.

19. A method of producing a magnetic recording disk substrate according to claim 17, wherein the magnetic recording disk raw substrate is an aluminum magnetic recording disk substrate that is chemically plated with Ni—P.

20. A method of producing a magnetic recording disk substrate according to claim 18, wherein the magnetic recording disk raw substrate is an aluminum magnetic recording disk substrate that is chemically plated with Ni—P.
